(19) United States
(12) Patent Application Publication
(10) Pub. No.: US 2022/0226948 A1
(43) Pub. Date: Jul. 21, 2022

(54) MULTI-SPINDLE FULLY AUTOMATIC VERTICAL MACHINING CENTER

(71) Applicant: KEDE NUMERICAL CONTROL CO., LTD., Dalian, Liaoning (CN)

(72) Inventors: Hu CHEN, Dalian, Liaoning (CN); Changlin DU, Dalian, Liaoning (CN); Lianyang WANG, Dalian, Liaoning (CN); Rui TANG, Dalian, Liaoning (CN); Shuqiang YIN, Dalian, Liaoning (CN); Ang LI, Dalian, Liaoning (CN); Xinglin GONG, Dalian, Liaoning (CN); Shaozhi LI, Dalian, Liaoning (CN)

(21) Appl. No.: 17/605,145

(22) PCT Filed: Jul. 7, 2020
(86) PCT No.: PCT/CN2020/100616

§ 371 Date: Oct. 20, 2021

(30) Foreign Application Priority Data
Jul. 19, 2019 (CN) 201910657286.3

(51) Int. Cl. B23Q 3/157; B23Q 1/01; B23Q 7/14

(52) U.S. Cl. CPC B23Q 3/15706; B23Q 1/01; B23Q 2230/002; B23Q 7/1405; B23Q 3/15724

(57) ABSTRACT

The invention discloses a multiple-spindle full-automatic vertical machining center, which comprises an actuator, a lathe bed, a feeding area, a tooling area, a machining area and a tool changer area. The actuator comprises a ram, a saddle and a sliding table, the feeding area crosses the lathe bed, and the feeding area and the tool changer area are respectively located on two opposite sides of the machining area, the feeding area is located at a forefront end of the machining center, and the actuator moves above the feeding area, the tooling area, the machining area and the tool changer area. Compared with the prior art, a conveyor belt is arranged in front of the whole machine tool and crosses the machine tool, a length of the conveyor belt may be increased or decreased as required, and by increasing the length of the conveyor belt, more raw materials and finished parts may be stored, so labor is saved.

### BACKGROUND OF THE INVENTION

### 1. Technical Field

The invention relates to the technical field of machining, in particular to a multiple-spindle full-automatic vertical machining center.

### 2. Description of Related Art

A vertical machining center generally consists of a lathe bed, a sliding table, a saddle, a ram, a cradle, a rotary table and a spindle, etc. A workpiece is fixed on the rotary table, and the spindle moves through an XYZ axis and an AC axis to perform complex machining on the workpiece.

At present, a vertical machining center with a conveyor belt which may realize automatic loading and unloading generally has only one spindle head, and only one part may be machined at a time. Moreover, due to the inability to realize automatic loading and unloading, labor is wasted and efficiency is low.

### BRIEF SUMMARY OF THE INVENTION

The invention provides a multiple-spindle full-automatic vertical machining center to overcome the above technical problems.

The invention comprises an actuator, a lathe bed, a feeding area, a tooling area, a machining area and a tool changer area.

The actuator comprises a ram, a saddle and a sliding table, the feeding area crosses the lathe bed, the feeding area and the tool changer area are respectively located on two opposite sides of the machining area, the feeding area is located at a forefront end of the machining center, and the actuator moves above the feeding area, the tooling area, the machining area and the tool changer area.

Further, the feeding area is a conveyor belt, a plurality of reloading areas are distributed on the conveyor belt at equal intervals, and each reloading area is provided with a plurality of station points for placing raw materials.

Further, the machining area comprises a cradle rotary table and worktables, and the number of the worktables is the same as that of the station points on each reloading area.

The tool changer area comprises a chain tool rest and cutters fixed on the chain tool rest.

Further, the tooling area comprises a clamping tool and a bracket, the bracket is used for fixing the clamping tool, and the tooling area is located between the feeding area and the machining area.

Further, the tooling area comprises a clamping tool, and the clamping tool is fixed on the chain tool rest.

Further, the ram fixes a plurality of spindle heads whose number is the same as that of the worktables, and the spindle heads may be connected with the cutters and the clamping tool through movement.

Further, a distance the conveyor belt moves each time is a distance between every two reloading areas.

Further, the tool changer area further comprises a tool changer door, and the tool changer door is arranged between the tool changer area and the machining area.

Compared with the prior art, a conveyor belt is arranged in front of the whole machine tool and crosses the machine tool, a length of the conveyor belt may be increased or decreased as required, and by increasing the length of the conveyor belt, more raw materials and finished parts may be stored, so labor is saved.

### BRIEF DESCRIPTION OF THE SEVERAL VIEWS OF THE DRAWINGS

In order to more clearly explain the embodiments of the invention or the technical solution in the prior art, the following will briefly introduce the drawings needed in the description of the embodiments or the prior art. Obviously, the drawings in the following description are only some embodiments of the invention. For those of ordinary skill in the art, other drawings can be obtained according to the provided drawings without paying creative labor.

FIG. 1 is an overall structural diagram of the invention;

FIG. 2 is a structural diagram when a tool changer door is open according to the invention;

FIG. 3 is an overall structural diagram when raw materials are machined into finished parts according to the invention; and

FIG. 4 is an overall structural diagram when finished parts are on a conveyor belt according to the invention.

### DETAILED DESCRIPTION OF THE INVENTION

In order to clarify the purpose, technical solution and advantages of the embodiments of the invention, the technical solution in the embodiments of the invention will be described clearly and completely below with reference to the drawings in the embodiments of the invention. Obviously, the described embodiments are only part of the embodiments of the invention, not all of the embodiments. Based on the embodiments of the invention, all other embodiments obtained by those of ordinary skill in the art without creative labor are within the scope of the invention.

The invention comprises an actuator 4, a lathe bed 9, a feeding area, a tooling area, a machining area and a tool changer area.

The actuator 4 comprises a ram 1, a saddle 2 and a sliding table 3, the feeding area crosses the lathe bed 9, the feeding area and the tool changer area are respectively located on two opposite sides of the machining area, the feeding area is located at a forefront end of the machining center, and the actuator 4 moves above the feeding area, the tooling area, the machining area and the tool changer area. Further, the feeding area is a conveyor belt 7, a plurality of reloading areas 15 are distributed on the conveyor belt at equal intervals, and each reloading area 15 is provided with a plurality of station 6 points for placing raw materials 16.

Further, the machining area comprises a cradle rotary table 8 and worktables 14, and the number of the worktables 14 is the same as that of the station points 6 on each reloading area 15.

The tool changer area comprises a chain tool rest and cutters 11 fixed on the chain tool rest.

Further, the tooling area comprises a clamping tool 12 and a bracket 13, the bracket 13 is used for fixing the clamping tool 12, and the tooling area is located between the feeding area and the machining area.

Further, the tooling area comprises a clamping tool 12, and the clamping tool 12 is fixed on the chain tool rest.

Further, the rain 1 fixes a plurality of spindle heads 10 whose number is the same as that of the worktables 14, and the spindle heads 10 may be connected with the cutters 11 and the clamping tool 12 through movement.

Further, a distance the conveyor belt moves each time is a distance between every two reloading areas 15.

Further, the tool changer area further comprises a tool changer door 5, and the tool changer door 5 is arranged between the tool changer area and the machining area.

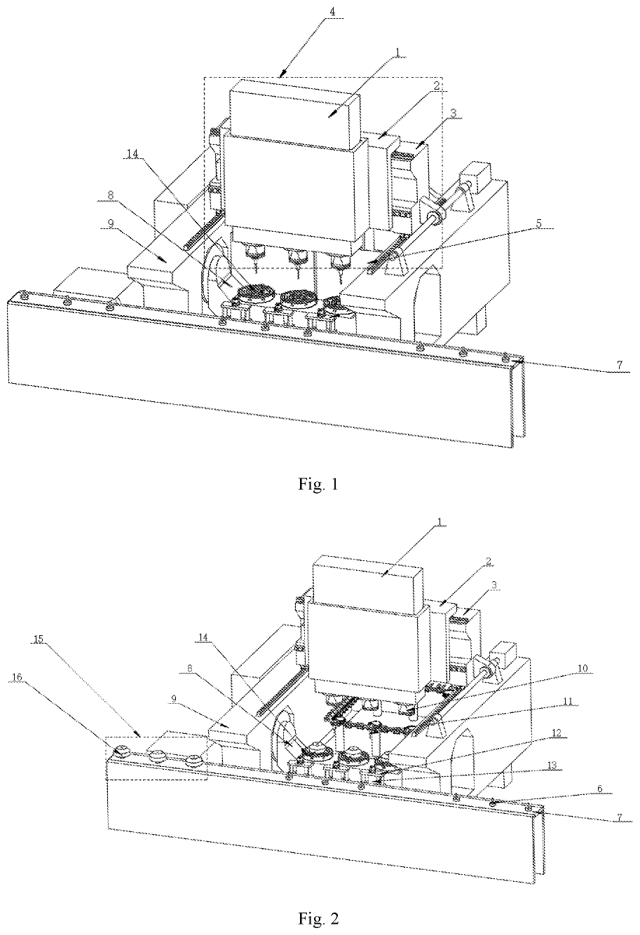

Embodiment 1: Specifically, as shown in FIG. 1, the sliding table 3 moves forward, that is, in the direction of the conveyor belt 7, so that the ram 1 reaches the tooling area, and a control end of the machine tool automatically adjusts the position of the saddle 2 to keep a main shaft of the ram 1 concentric with the clamping tooling 12 below. At this point, the position of the ram 1 is set as point A. In this embodiment, three spindle heads 10 are provided, and at this point, the rain 1 moves downward to drive the three spindle heads 10 to grab the clamping tool 12 below and ascend to a specified height.

As shown in FIG. 2, the sliding table 3 continues to move forward, so that the ram 1 reaches above the conveyor belt 7, the plurality of reloading areas 15 are equidistantly arranged on the conveyor belt 7, the conveyor belt 7 operates intermittently, and a distance the conveyor belt operates each time is the distance between two adjacent reloading areas. Each reloading area 15 is provided with three station points 6 for fixing raw materials. The conveyor belt 7 starts to move, and the central axes of the three spindle heads 10 are respectively concentric with the raw materials 16 on the three station points 6. At this point, the position of the ram 1 is set as point B.

The ram 1 moves downward, the raw materials 16 are clamped by the clamping tool 12, the ram 1 rises to a specified height, and the sliding table 3 moves backward to make the ram 1 reach just above the worktable 14. At this point, the position of the ram 1 is set as point C, the ram moves downward, and the clamping tool 12 is released to unload the raw materials 16 on the worktable. A clamping device on the worktable positions and clamps the raw materials, and the ram 1 rises to the specified height again. The ram 1 moves to point A and moves downward, the clamping tool 12 is removed and placed on the bracket 13, and then the ram 1 rises to the specified height again.

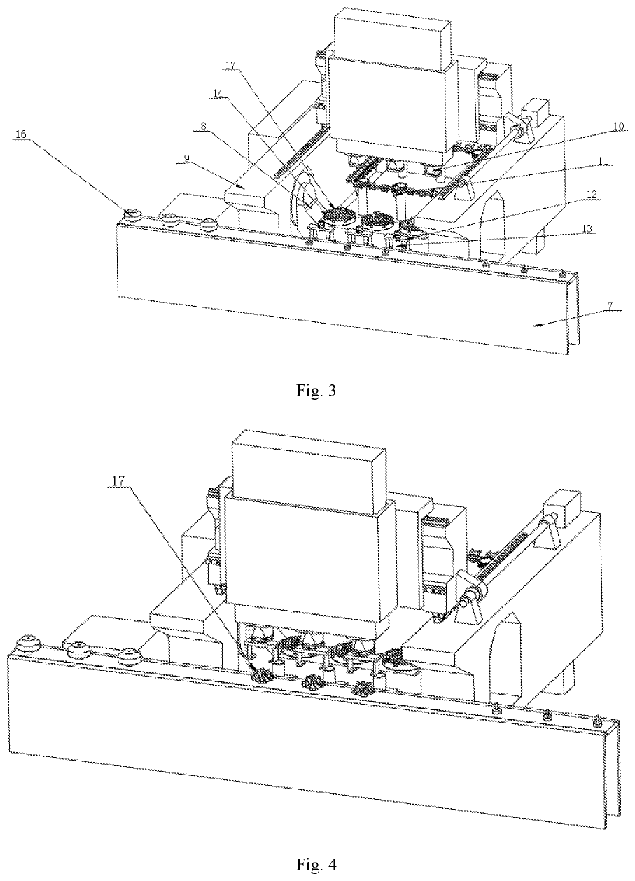

The tool changer door 5 is opened, and the sliding table 3 moves backward, so that the ram 1 drives the three spindle heads 10 to reach a designated tool changing point in the tool changer area. At this point, the position of the ram 1 is set to point D, and the chain tool rest with the cutters 11 fixed thereon rotates to move a cutter to be used to the tool changing point. The ram 1 moves downward, so that the spindle head grabs the cutter at the corresponding tool change point, and then the ram 1 rises to a specified height and moves to point C. At the same time, the tool changer door 5 is closed, and the preparation work before machining is completed. As shown in FIG. 3, the ram 1 moves downward, so that the raw materials are machined by the cutter and a finished part 17 is obtained.

After machining, the tool changer door 5 is opened, and the ram 1 rises to a specified height and moves backward to point D. At the same time, the clamping device of the worktable loosens the finished part, the spindle head loads the cutter on the chain tool rest, the ram 1 moves forward to point A, and the ram 1 moves downward to grab the clamping tool. At this point, the tool changer door 5 is closed and the ram 1 rises to a specified height. The ram 1 moves backward to point C, at the same time, the ram 1 moves downward, so that the clamping tool clamps the finished part 17, and the ram 1 rises to the specified height again. As shown in FIG. 4, the ram 1 moves to point B, the ram 1 moves downward, the clamping tool is released, the finished part is unloaded at the station point below, the finished part is transported outside the machine tool by the conveyor belt, then the next batch of raw materials are sent to the inside of the machine tool, and the above steps are repeated.

Embodiment 2: On the basis of Embodiment 1, the clamping tool may also be placed on the chain tool rest together with the cutters, and the grasping process of the clamping tool by the spindle head is the same as that of the cutters, which will not be repeated here.

In this application, the tool changer door 5 is closed during machining, which effectively blocks machining waste and dust outside the tool changer area, and ensures the cleanliness of the tool changer area; and one side of the actuator 4 is provided with the conveyor belt, and the other side is provided with the worktables and the tool changer area, so that the working stroke of the spindle head is shortened, and the whole machining process is simpler and more convenient.

Finally, it should be noted that the above embodiments are only used to illustrate the technical solutions of the invention, but not to limit it. Although the invention has been described in detail with reference to the foregoing embodiments, those of ordinary skill in the art should understand that the technical solutions described in the foregoing embodiments can still be modified, or some or all of the technical features can be equivalently replaced, and these modifications or substitutions do not make the essence of the corresponding technical solutions deviate from the scope of the technical solutions of each embodiment of the invention.

What is claimed is:

1. A multiple-spindle full-automatic vertical machining center, comprising an actuator (4), a lathe bed (9), a feeding area, a tooling area, a machining area and a tool changer area;
wherein the actuator (4) comprises a ram (1), a saddle (2) and a sliding table (3), the feeding area crosses the lathe bed (9), the feeding area and the tool changer area are respectively located on two opposite sides of the machining area, the feeding area is located at a forefront end of the machining center, and the actuator (4) moves above the feeding area, the tooling area, the machining area and the tool changer area.

2. The multiple-spindle full-automatic vertical machining center according to claim 1, wherein the feeding area is a conveyor belt (7), a plurality of reloading areas (15) are distributed on the conveyor belt at equal intervals, and each reloading area (15) is provided with a plurality of station points (6) for placing raw materials (16).

3. The multiple-spindle full-automatic vertical machining center according to claim 2, wherein the machining area comprises a cradle rotary table (8) and worktables (14), the number of the worktables (14) is the same as that of the station points (6) on each reloading area (15), and the tool changer area comprises a chain tool rest and cutters (11) fixed on the chain tool rest.

4. The multiple-spindle full-automatic vertical machining center according to claim 3, wherein the tooling area comprises a clamping tool (12) and a bracket (13), the bracket (13) is used for fixing the clamping tool (12), and the tooling area is located between the feeding area and the machining area.

5. The multiple-spindle full-automatic vertical machining center according to claim 3, wherein the tooling area comprises a clamping tool (12), and the clamping tool (12) is fixed on the chain tool rest.

6. The multiple-spindle full-automatic vertical machining center according to claim 4 or 5, wherein the ram (1) fixes a plurality of spindle heads (10) whose number is the same as that of the worktables (14), and the spindle heads (10) may be connected with the cutters (11) and the clamping tool (12) through movement.

7. The multiple-spindle full-automatic vertical machining center according to claim 6, wherein a distance the conveyor belt moves each time is a distance between every two reloading areas (15).

8. The multiple-spindle full-automatic vertical machining center according to claim 7, wherein the tool changer area further comprises a tool changer door (5), and the tool changer door (5) is arranged between the tool changer area and the machining area.
